(19) United States
(12) Patent Application Publication
(10) Pub. No.: US 2011/0153199 A1
(43) Pub. Date: Jun. 23, 2011

(54) NAVIGATION APPARATUS

(75) Inventors: Ryuichi MORIMOTO, Kobe-shi (JP); Munenori MAEDA, Kobe-shi (JP)

(73) Assignee: FUJITSU TEN LIMITED, Kobe-shi (JP)

(21) Appl. No.: 12/966,482

(22) Filed: Dec. 13, 2010

(30) Foreign Application Priority Data
Dec. 17, 2009 (JP) 2009-286620

(51) Int. Cl. G01C 21/00

(52) U.S. Cl. 701/201; 701/208

(57) ABSTRACT

A drive recorder for installation in a vehicle detects occurrence of predetermined events such as an accident, and records an “event occurrence location” that is a location of the vehicle at the time of the event occurrence. A navigation apparatus obtains the “event occurrence location” recorded by the drive recorder, and if there is the “event occurrence location” in the range of a map displayed on a display, the navigation apparatus superimposes a warning mark on the event occurrence location. Thereby the location, where the event occurred actually, is indicated on the map. Thus it is possible to inform the location where an attention is required for driving, adapting to the actual driving.

### BACKGROUND OF THE INVENTION

1. Field of the Invention

The invention relates to technologies for displaying recorded data recorded by a drive recorder.

2. Description of the Background Art

Conventionally, a navigation apparatus, called a car navigation, for installation in a vehicle has been known. The navigation apparatus obtains a current location of a vehicle, using a GPS and the like, and displays a map that explicitly identifies the vehicle location. Moreover, if a destination is set, the navigation apparatus finds a route from the vehicle location to the destination and provides a user with the route guidance.

A recent navigation apparatus provides the user with a variety of guidance other than the route guidance. For example, if there are locations where an attention is required in driving in an area displayed in a map, such as a sharp curve and a railroad crossing, the navigation apparatus displays a predetermined warning mark in a corresponding position of the map. Also, the navigation apparatus outputs guidance sounds to warn the user, when his/her vehicle approaches those locations.

The above-mentioned navigation apparatus informs the user of the locations where an attention is required in driving. The locations to be informed of are predetermined dangerous locations which are generally expected to be dangerous, such as a sharp curve and a railroad crossing. Therefore, the above-mentioned navigation apparatus cannot inform the user of the locations which are dangerous in actual driving, such as a location where an accident happened actually and a location where a driver actually sensed danger. In order to improve safety, it is desirable to inform the driver of the locations where an attention is required in driving, readily adapting to actual driving.

### SUMMARY OF THE INVENTION

According to one aspect of this invention, a navigation apparatus for installation in a vehicle includes: a data obtaining unit that obtains recorded data, recorded by a drive recorder that records the recorded data including an event occurrence location where an event occurred; a location obtaining unit that obtains a vehicle location that is a current location of the vehicle; and a display unit that displays a map that explicitly identifies the event occurrence location and the vehicle location.

The location where the event occurred is indicated on the map, and therefore it is possible to inform a user of the location where an attention is required in driving, adapting to actual driving. As a result, the user can drive keeping in mind the location, and then safety is improved.

According to another aspect of this invention, the recorded data includes a plurality of the event occurrence locations and further includes moving image data that shows image data recorded when the event occurred at each respective event occurrence location. The navigation apparatus further includes a receiver that receives a selection of any of the plurality of event occurrence locations on the map from the user. The display unit plays back and displays the moving image data of the event that occurred at one of the plurality of event occurrence locations which is selected by the user.

By selecting the event occurrence location on the map, the moving image data of the event that occurred at the event occurrence location is played back and displayed. Thereby, the user can understand the type of event that occurred at a specific location on the map in the past with a concrete video image, and the safety is improved.

According to another aspect of this invention, an in-vehicle display system for installation in a vehicle includes a drive recorder that records recorded data including an event occurrence location where an event occurred; a location obtaining unit that obtains a vehicle location that is a current location of the vehicle; and a display unit that displays a map that explicitly identifies the event occurrence location and the vehicle location.

According to another aspect of this invention, a map displaying method for displaying a map in a vehicle includes the step of obtaining recorded data recorded by a drive recorder that records the recorded data including an event occurrence location where an event occurred, the step of obtaining a vehicle location that is a current location of the vehicle, and the step of displaying a map that explicitly identifies the event occurrence location and the vehicle location.

Therefore, an object of the invention is to inform the user of the location where an attention is required in driving, adapting to actual driving.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows an exemplary configuration of an in-vehicle display system;

FIG. 2 shows an exemplary configuration of an in-vehicle display system;

FIG. 3 shows a configuration of a navigation apparatus;

FIG. 4 shows a configuration of a drive recorder;

FIG. 5 shows a flow of process where a drive recorder records recorded data;

FIG. 6 shows a status where recorded data is stored in a memory card;

FIG. 7 shows a flow of process where a navigation apparatus displays recorded data;

FIG. 8 shows an exemplary map on which warning marks are superimposed;

FIG. 9 shows moving image data being played back and displayed;

FIG. 10 shows a flow of process where a navigation apparatus sets a route;

FIG. 11 shows an exemplary map on which a basic route is displayed;

FIG. 12 shows an exemplary map on which a basic route and a detour route are displayed;

FIG. 13 shows a flow of process where a navigation apparatus provides route guidance

FIG. 14 shows an output of guidance sound conceptually;

FIG. 15 shows an exemplary map on which warning marks are superimposed in a second embodiment

FIG. 16 shows exemplary display of a list of moving image data;

FIG. 17 shows an exemplary configuration of an in-vehicle display system;

FIG. 18 shows exemplary display of a list of moving image'data; and

FIG. 19 shows an exemplary configuration of an in-vehicle display system;

### DESCRIPTION OF THE EMBODIMENTS

Embodiments of this invention are explained hereinbelow with reference to the drawings.

### First Embodiment

### 1-1. Configuration of System

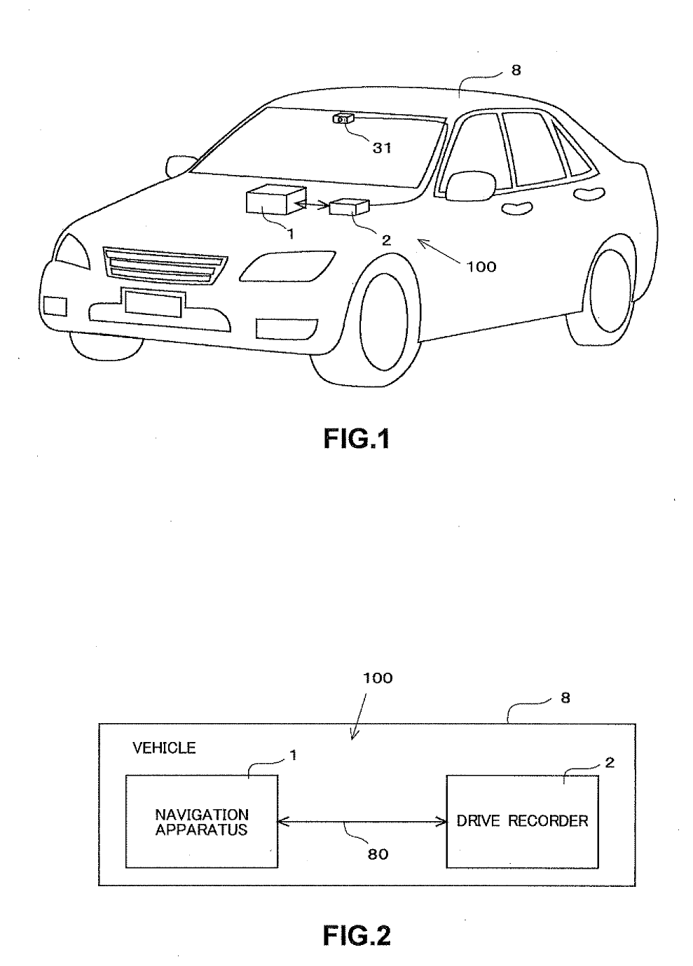

FIGS. 1 and 2 show a configuration outline of an in-vehicle display system 100 according to this embodiment. The in-vehicle display system 100 installed in a vehicle 8 provides a variety of information to a user in a cabin (typically a driver), and includes a navigation apparatus 1 and a drive recorder 2. In other words, the navigation apparatus 1 and the drive recorder 2 are installed in the same vehicle 8.

The navigation apparatus 1 includes a display. A screen of the display is installed on an instrument panel or the like of the vehicle 8 so that the user can view the screen. On the other hand, the drive recorder 2 is configured separately from the navigation apparatus 1 and is located at an appropriate position in the cabin.

The navigation apparatus 1 has a function to display a map explicitly identifying a vehicle location that is a current location of the vehicle 8, on the display, and to provide route guidance to a set destination, as a basic function On the other hand, a basic function of the drive recorder 2 is to obtain image data by constantly capturing images of surroundings of the vehicle 8 with a camera 31 installed on the vehicle 8, assemble the image data obtained before and after occurrence of an event such as an accident if it occurs, and record the assembled image data as moving image data.

As shown in FIG. 2, the navigation apparatus 1 and the drive recorder 2 of the in-vehicle display system 100 are connected through an in-vehicle LAN 80 such as CAN and MOST, and the navigation apparatus 1 and the drive recorder 2 can intercommunicate. Thereby, the navigation apparatus 1 can obtain the recorded data, recorded by the drive recorder 2, and can display the recorded data on the display included in the navigation apparatus 1.

### 1-2. Configuration of Navigation Apparatus

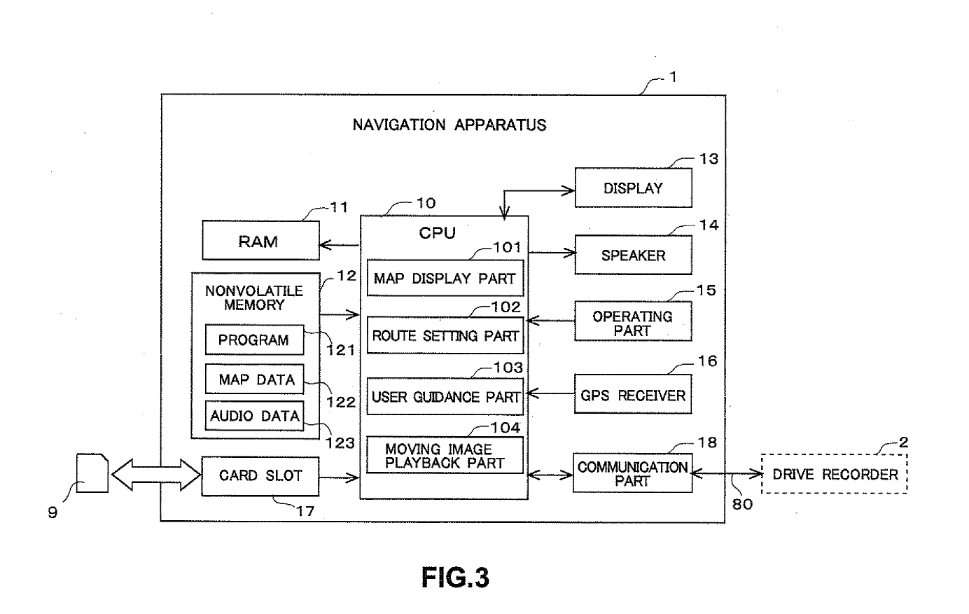

FIG. 3 shows a configuration of the navigation apparatus 1. The navigation apparatus 1 includes a microcomputer as a controller that controls an entire apparatus. Concretely, the navigation apparatus 1 includes a CPU 10 that implements a variety of control functions by arithmetic processing, a RAM 11 that becomes a working area for the arithmetic processing, and a nonvolatile memory 12 that stores a variety of data. The nonvolatile memory 12, for example, includes a hard disc, a flash memory and the like, and the nonvolatile memory 12 stores a program 121 as firmware, map data 122, audio data 123, and the like, used for route guidance for the user.

Moreover, the navigation apparatus 1 includes the above-mentioned display 13 that displays a variety of information to the user, a speaker 14 that outputs a guidance sound for the user, and an operating part 15 that receives a variety of operations from the user.

The display 13 includes a liquid crystal display and the like, and displays a map included in the map data 122 and a variety of information such as a route to a destination. The display 13 has a touch-screen function, and thereby it is possible to receive a variety of instructions and a designation of a position on a map from the user. The speaker 14 outputs a variety of guidance sounds included in the audio data 123. The operating part 15 is located at a position where the user can operate easily, and receives a variety of user operations. The user operations received by the display 13 which has the touch-screen function, and by the operating part 15 are input to the CPU 10 as signals.

Furthermore, the navigation apparatus 1 includes a GPS receiver 16, a card slot 17, and a communication part 18.

The GPS receiver 16 receives signals from a plurality of GPS satellites and obtains the vehicle location that is the current location of the vehicle 8. The GPS receiver 16 obtains the vehicle location as location information represented by latitude and longitude of the earth, and outputs the vehicle location to the CPU 10.

The card slot 17 is configured so that a memory card 9 that is a portable recording medium can be removed. The card slot 17 reads data from the memory card 9 when inserted and writes the data into the inserted memory card 9. It is possible to update the program 121, the map data 122 and the audio data 123, stored in the nonvolatile memory 12, by reading the memory card 9 in which new programs and data are stored, through the card slot 17.

The communication part 18 is connected to the in-vehicle LAN 80 and communicates with another apparatus connected to the in-vehicle LAN 80. The communication part 18 allows the navigation apparatus 1 to communicate with the drive recorder 2 and to obtain the recorded data recorded by the drive recorder 2.

A function of controlling each part of such navigation apparatus 1 is implemented by the CPU 10 performing arithmetic processing in accordance with the program 121 previously stored in the nonvolatile memory 12. A map display part 101, a route setting part 102, a user guidance part 103, and a moving image playback part 104, shown in the FIG. 3, are a part of functions that are implemented by the CPU 10 performing arithmetic processing.

The map display part 101 has a function related to display of a map on the display 13. For example, based on the vehicle location obtained by the GPS receiver 16, the map display part 101 obtains the surrounding map of the vehicle location from the map data 122 stored in the nonvolatile memory 12, and displays the surrounding map of the vehicle location on the display 13. Also, if there are any specific locations to be notified to the user in the range of the map displayed on the display 13, the map display part 101 displays a predetermined mark, superimposing it on a corresponding position in the map.

The route setting part 102 has a function related to route setting. For example, the route setting part 102 receives a desired destination from the user and finds out a route from the vehicle location obtained by the GPS receiver 16, to the destination.

The user guidance part 103 has a function related to route guidance for the user. For example, the user guidance part 103 displays an arrow that indicates a direction at an intersection on the display 13 and outputs a guidance sound that announces the direction from a speaker so that the user can follow a route being set by the route setting part 102.

The moving image playback part 104 has a function to play back and display moving image data, recorded by the drive recorder 2 on the display 13. Details of the functions of the map display part 101, the route setting part 102, the user guidance part 103, and the moving image playback part 104 are described later.

### 1-3. Configuration of Drive Recorder

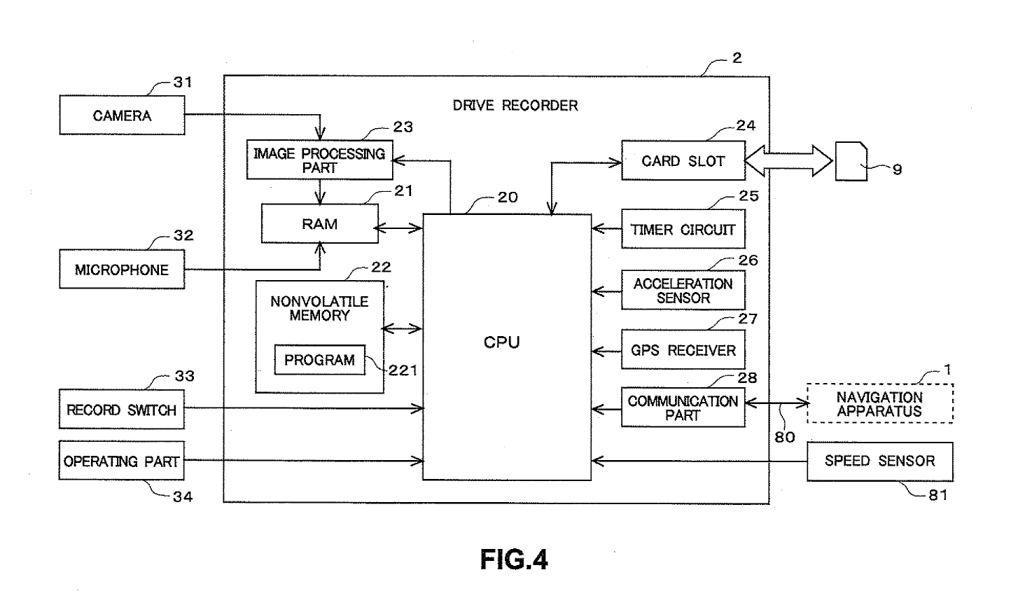

FIG. 4 shows a configuration of the drive recorder 2. The drive recorder 2 includes a microcomputer as a controller that controls an entire apparatus. Concretely, the drive recorder 2 includes a CPU 20 that implements a variety of control functions by an arithmetic processing, a RAM 21 that becomes a working area for the arithmetic processing, and a nonvolatile memory 22 that stores a variety of data. The nonvolatile memory 22, for example, includes a hard disc, a flash memory, and the like, and stores a program 221 as firmware and a setting parameter and the like. A function of controlling each part of the drive recorder 2 is implemented by the CPU 20 performing arithmetic processing in accordance with the program 221 stored in the nonvolatile memory 22.

The drive recorder 2 includes the camera 31 and a microphone 32, and these are located at an appropriate position in the vehicle 8 separately from a body part of the drive recorder 2. The camera 31 includes a lens and an image sensor, and can obtain image data electronically. The camera 31 is arranged near the upper edge of a front windshield, with an optical axis thereof orientating forward of the vehicle 8 (refer to the FIG. 1), and obtains the image data that shows the forward area of the vehicle 8. The microphone 32 collects sounds in the outside of the cabin and obtains audio data.

The drive recorder 2 includes an image processing part 23 that processes image data obtained by the camera 31. The image processing part 23 implements predetermined image processing on a signal of the image data being input from the camera 31, such as A/D conversion, luminance correction and contrast correction, and generates digital image data in a predetermined format such as JPEG and the like. The image data processed in the image processing part 23 is recorded in the RAM 21.

A part of a storage area of the RAM 21 is used as a ring buffer. In this ring buffer, the image data processed in the image processing part 23 and the audio data obtained by the microphone 32 are constantly stored. In the ring buffer, after the data is stored until the last area is filled, new data is stored at the first area by turning back. In this way, the oldest data is overwritten with new data sequentially in the ring buffer. Therefore, image data and audio data for a past certain period of time are constantly stored in the RAM 21. In this embodiment, image data and audio data for at least 40 seconds are stored in the ring buffer.

The drive recorder 2 includes a card slot 24, a timer circuit 25, an acceleration sensor 26, a GPS receiver 27, and a communication part 28.

The card slot 24 is configured so that the memory card 9 be removable therefrom. The card slot 24 reads data from the memory card 9 when inserted and writes the data into the inserted memory card 9. If predetermined events such as an accident and the like occur, the image data and the audio data, stored in the ring buffer of the RAM 21, are converted into moving image data by an instruction of the CPU 20, and the moving image data is recorded in the memory card 9 inserted into the card slot 24. It is possible to update the program 221, stored in the nonvolatile memory 22, by reading the memory card 9 in which new programs are stored, through the card slot 24.

The timer circuit 25 generates a signal corresponding to the current time and outputs it to the CPU 20. The timer circuit 25 has a built-in battery, thereby operates and measures time exactly without supply of an external power.

The acceleration sensor 26 detects acceleration representing the magnitude of an impact applied to the vehicle 8, in units of G of the gravity acceleration. For example, the acceleration sensor 26 detects acceleration corresponding to mutually-perpendicular three axes or two axes and outputs it to the CPU 20.

The GPS receiver 27 receives signals from a plurality of GPS satellites and obtains the vehicle location that is the current location of the vehicle 8. The GPS receiver 27 obtains the location information represented by latitude and longitude of the earth, as the vehicle location, and outputs the location information to the CPU 20.

The communication part 28 is connected to the in-vehicle LAN 80 and communicates with another apparatus connected to the in-vehicle LAN 80. The communication part 28 allows the drive recorder 2 to communicate with the navigation apparatus 1 and to transfer recorded data to the navigation apparatus 1.

The drive recorder 2 includes a record switch 33 and an operating part 34 as members for receiving the instructions from the user. These members are arranged at the appropriate position in the vehicle 8 near a steering wheel separately from the body part of the drive recorder 2.

The record switch 33 is the switch to receive the instructions to record the moving image data in the memory card 9. By pushing down the record switch 33, the user can record moving image data in the memory card 9 at a desired time when the user senses danger, even if a collision accident and the like do not actually occur. The operating part 34 includes a plurality of buttons and receives the inputs of a variety of settings from the user. Details of the user operation received by the record switch 33 and the operating part 34 are input to the CPU 20 as signals.

The drive recorder 2 is connected with a vehicle speed sensor 81 located in the vehicle 8. The vehicle speed sensor 81 detects the current running speed (km/h) of the vehicle 8 and outputs it to the CPU 20.

### 1-4 Operation of Drive Recorder

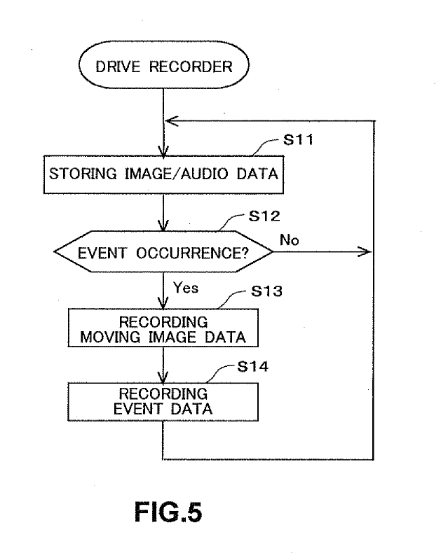

Next, the operation of the drive recorder 2 is explained. FIG. 5 shows a flow of process where the drive recorder 2 records recorded data in the memory card 9. At the time of starting of this operation, the memory card 9 is presumed to be inserted into the card slot 24. Also, this operation is implemented under the control of the CPU 20 unless otherwise mentioned.

The drive recorder 2 starts up by turning an ignition switch on and stops by turning the ignition switch off. Immediately after starting up and completing predetermined initial processing, the drive recorder 2 starts obtaining image data that shows the surroundings of the vehicle, with the camera 31, and starts obtaining audio data with the microphone 32. The obtained image data and audio data are stored in an area of the ring buffer of the RAM 21 (Step S11). After that, image data and audio data are continuously stored in the RAM 21 while the drive recorder 2 is running. The image data, for example, is stored at a frame rate of 30 fps (30 frames per second).

While image data and audio data are continuously stored, whether a predetermined event occurred is observed (Step S12). In the drive recorder 2 of this embodiment, the condition for judging that a predetermined event occurred is any of the following conditions (A) to (C).

(A) In a case where the acceleration sensor 26 detects acceleration of equal to or more than predetermined acceleration continuously for a time of equal to or more than a predetermined time. For example, in a case where acceleration of 0.40 G or more is continuously detected for 100 milliseconds or more.

(B) In a case where a difference in speed of the vehicle 8 detected by the vehicle speed sensor 81 within a predetermined period becomes equal to or more than a threshold value. For example, in a case where the speed is reduced by 14 km/h or more per 1 second while the vehicle is moving at 60 km/h or more.

(C) In a case where the record switch 33 is operated by the user.

The condition (A) shows a situation where a relatively-good/fast acceleration occurs and a probability of occurrence of collision accident of the vehicle 8 is high. An event that satisfies this condition (A) is called “G detection.”

The condition (B) shows a situation where rapid deceleration occurs and a probability of imminence of accident is high. An event that satisfies this condition (B) is called “rapid deceleration.”

The condition (C) shows a situation where the user (typically the driver of the vehicle 8) senses danger and decides to record data. An event that satisfies this condition (C) is called “switching operation.”

If any event occurs (Yes at the Step S12), for example, image data and audio data for a total of 20 seconds including 12 seconds before event occurrence and 8 seconds after the event occurrence, are retrieved from the ring buffer of the RAM 21. One piece of moving image data is generated by utilizing the retrieved image data and the retrieved audio data. This moving image data shows a situation at the time of the event occurrence. Concretely, the moving image data shows image data of surroundings of the vehicle 8 at the time of the event occurrence. The generated moving image data is recorded in the memory card 9 (Step S13).

Furthermore, event data that shows the situation at the time of the event occurrence is recorded in the memory card 9 (Step S14). The event data includes an “event time” that is a time when the event occurred, an “event occurrence location” that is a location of the vehicle 8 at the time when the event occurred, an “event type” that indicates the type of the event that occurred, and a “file name” of the moving image data generated at the time when the event occurred. The time obtained by the timer circuit 25 is used for the “event time,” and the vehicle location obtained by the GPS receiver 29 is used for the “event occurrence location.” The “event type” is one of the “G detection,” “rapid deceleration” and “switching operation” corresponding to the satisfied condition among the conditions (A) to (C)

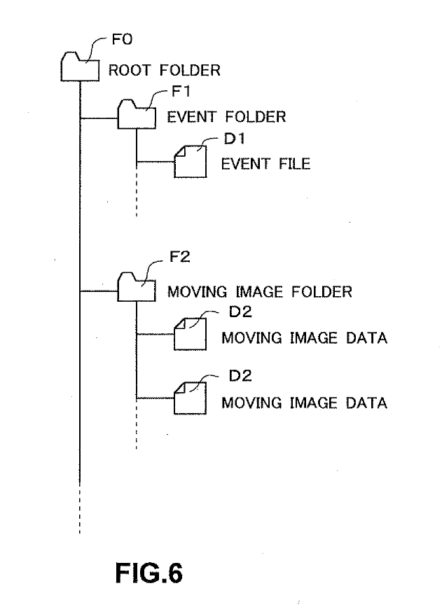

FIG. 6 shows a status in which the recorded data is stored in the memory card 9. A hierarchical folder structure (hierarchical directory structure) is adopted for a data storage structure in the memory card 9, and recorded data (moving image data and event data) recorded by the drive recorder 2 is stored in one of folders. A root folder F0 is set in the top layer of the hierarchical folder structure. An event folder F1 and a moving image folder F2 are set directly beneath the root folder F0 as sub folders.

An event file D1 is stored in the event folder F1. In this event file D1, event data that shows a situation at the time when an event occurred is recorded. In the event file D1, event data related to one event is regarded as one record. If a plurality of events occur, a plurality of records are recorded in the event file D1. Each record includes an “event time,” an “event occurrence location,” an “event type” and a “file name” that are mentioned above, and the like. Therefore, an “event time,” an “event occurrence location,” an “event type” and a “file name,” related to one event are correlated and recorded.

Moving image data D2 obtained when an event occurred is stored in the moving image folder F2. One file is created for one event, and the moving image data D2 related to one event is recorded as one file. Each moving image data D2 is identified by its “file name” and is correlated to one record (an event data related to one event) in the event file D1.

### 1-5. Indication of Recorded Data

In this way, the recorded data recorded by the drive recorder 2 can be displayed in the navigation apparatus 1. Concretely, a predetermined warning mark is superimposed on the map displayed on the display 13 and an “event occurrence location” is explicitly identified. By touching the warning mark, it is possible to play back and display the moving image data obtained when the event occurred.

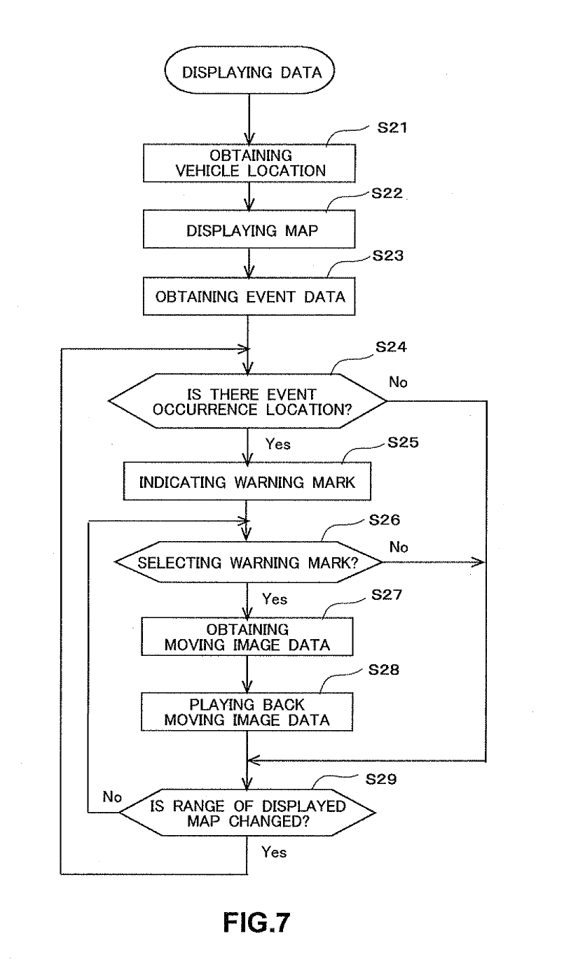

FIG. 7 shows a flow of data indication process where the recorded data recorded by the drive recorder 2 is displayed in the navigation apparatus 1. This data indication process is implemented under the control of the map display part 101 in the CPU 10 unless otherwise mentioned.

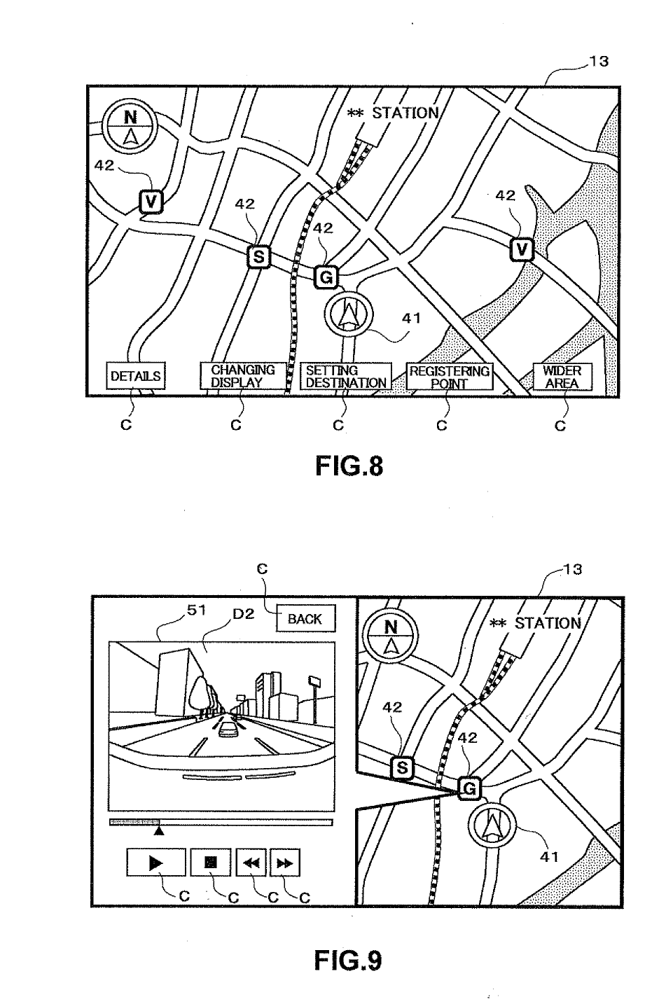

First, the vehicle location is obtained by the GPS receiver 16 (Step S21). Subsequently, a map of surroundings of the obtained vehicle location is obtained from the map data 122 stored in the nonvolatile memory 12 and is displayed on the display 13. On this map, a vehicle mark 41 that explicitly identifies the vehicle location is superimposed as shown in FIG. 8 (Step S22).

In principle, a range of the map displayed on the display 13 is set to place the vehicle location in an approximate center of a horizontal direction on the screen. However the range of the map can be changed by the user's predetermined operation. On the screen of the display 13, a variety of command buttons C are displayed. By touching the command button C, the user can give instructions a change of a scale size, setting of the destination, and the like.

After the map is displayed on the display 13, event data recorded by the drive recorder 2 is obtained (Step S23 in the FIG. 7). Concretely, a request signal that requests transmission of the event file D1 is transmitted to the drive recorder 2 from the communication part 18 in the navigation apparatus 1. Responding to this request signal, the drive recorder 2 retrieves the event file D1 from the memory card 9 and transmits the event file D1 to the navigation apparatus 1 from the communication part 28. Thereby, the navigation apparatus 1 obtains the event file D1 in which respective pieces of event data of events that occurred in the past are recorded.

Next, “event occurrence locations” of the respective pieces of event data are referenced, and decision is made whether there is any of the “event occurrence locations” in the range of the map displayed on the display 13 (Yes at the Step S24). If there is any of the “event occurrence locations,” a warning mark 42 is superimposed on the corresponding location on the map displayed on the display 13 and displayed, as shown in FIG. 8 (Step S25). In FIG. 8, four warning marks 42 are displayed on the map.

Thereby, an “event occurrence location” where an event occurred actually in the past, in other words, a location where a dangerous event such as an accident occurred during actual driving, or a location where the user sensed danger is shown on the display 13. Therefore, an “event occurrence location” is a problematic location for actual driving of the user and is a dangerous location where the user needs to pay attention. Also the vehicle location is indicated on the same screen. Therefore, a relationship between the vehicle location and the “event occurrence location” is shown. By referring to such screen of the display 13, the user can drive, keeping conscious of the location where the user needs to pay attention for actual driving. As a result, the safety is improved.

The aspect of the warning mark 42, displayed on an “event occurrence location,” varies depending on a type of an event that occurred at the location. For example, if the event type is the “G detection,” the warning mark 42 has an aspect of “G” surrounded by a rectangular frame. If the event type is the “rapid deceleration,” the warning mark 42 has an aspect of “V” surrounded by a rectangular frame, and if the event type is the “switching operation,” the warning mark 42 has an aspect of “S” surrounded by a rectangular frame. The event type is identified based on an “event type” of the same record as the “event occurrence location” shown by the warning mark 42.

In this way, the type of the event that occurred at the location is explicitly identified on the “event occurrence location” on the map. Thereby, the user can easily understand what type of the event occurred actually in the past on a specific location on the map. As a result, the user can drive keeping in mind the event type and improve the safety.

Each warning mark 42, displayed on the display 13, works as a selectable command button for the user through a touch-screen function of the display 13. In other words, the user can select an “event occurrence location” on the map. When any of the warning marks 42 is selected (Yes at the Step S26), moving image data of an event that occurred at the “event occurrence location” shown by the warning mark 42 is played back and displayed under the control, of the moving image playback part 104 in the CPU 10.

Concretely, a “file name” of the same record as the “event occurrence location” shown by the selected warning mark 42 is referenced. And then a request signal that requests transmission of the moving image data D2 of the “file name” is transmitted to the drive recorder 2 from the communication part 18 in the navigation apparatus 1. Responding to this request signal, the drive recorder 2 retrieves the moving image data D2 of the “file name” from the memory card 9 and transmits the moving image data D2 to the navigation apparatus 1 from the communication part 28. Thereby, the navigation apparatus 1 obtains the moving image data D2 obtained at the “event occurrence location” shown by the selected warning mark 42 (Step S27).

The obtained moving image data D2 is played back and is displayed on the display 13 as shown in FIG. 9 (Step S28). When the moving image data D2 is played back, the screen of the display 13 is divided into two areas of right and left screen areas. In the right screen area, a map including the selected warning mark 42 is displayed. On the other hand, in the left screen area, a playback area 51 for playing back the moving image data D2 is included. The left screen area is shown like a balloon from the selected warning mark 42 to indicate which of “event occurrence locations” is associated with the moving image data D2 to be played back. Also in the left screen area, the command button C related to a playback operation is displayed at the bottom of the playback area 51, and the command button C for going back to map display is displayed at the top of the playback area 51.

In this way, by selecting any of the “event occurrence locations” on the map displayed on the display 13, the moving image data D2 obtained at the selected “event occurrence location” is played back and displayed. Therefore, the user can understand what type of event occurred actually in the past at a specific location on the map with a concrete image. As a result, the user can drive keeping conscious of the situation of the “event occurrence location” concretely, and can improve the safety.

If the range of the map being displayed is changed (Yes at the Step S29 in FIG. 7) due to the user's instruction or a transfer of the vehicle location in a state where the map including the warning mark 42 is displayed as described above, the process goes back to the Step S24. If there is an “event occurrence location” in the range of the map after the range of the map is changed, the warning mark 42 is displayed. Therefore, even if the range of the map being displayed is changed, it is possible to inform the user of a location where the user needs to pay attention for actual driving.

### 1-6. Route Setting

The navigation apparatus 1 can also find out a route to a destination, taking account of an “event occurrence location” of the recorded data recorded by the drive recorder 2.

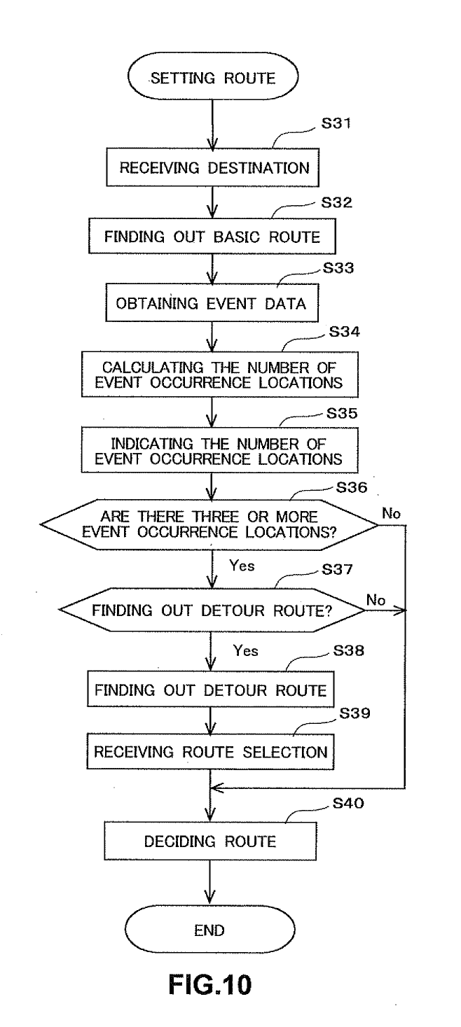

FIG. 10 shows a flow of a route setting process where the navigation apparatus 1 sets a route to a destination. This route setting process is implemented by touching the command button C (refer to FIG. 8) indicated as “Setting destination” on the screen of the display 13 that displays a map. Also, this route setting process is implemented under the control of the route setting part 102 in the CPU 10 unless otherwise mentioned.

First, a destination is set by the user's operation. A destination can be set, by designating a location on the map displayed in the display 13, by selecting one from registered locations, or by conducting a search using predetermined search keys (name, address, telephone number and the like) (Step S31).

After the destination is set, the map data 122 stored in the nonvolatile memory 12 is referenced, and a route from the vehicle location to the destination is found through a basic algorithm. In the basic algorithm, the shortest route from the vehicle location to the destination which uses a road having a predetermined width or greater is selected (Step S32). Hereinafter, a route that is found through the basic algorithm is referred to as a “basic route.”

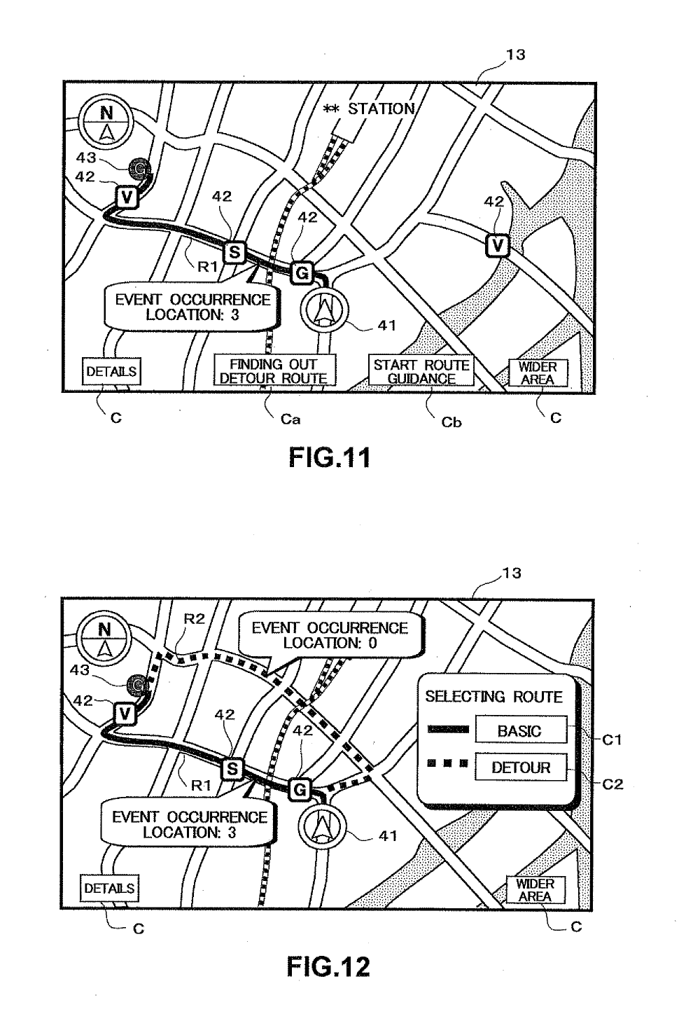

The basic route R1 found out is superimposed and displayed on the map displayed on the display 13 as shown in FIG. 11. Also a destination mark 43 is superimposed and displayed on the position of the destination on the map, and the basic route R1 is the shortest route, connecting the vehicle mark 41 and the destination mark 43.

After the basic route R1 is displayed on the display 13, event data recorded by the drive recorder 2 is obtained (Step S33 in FIG. 10). This process is the same as that of the step S23 shown in FIG. 7. Also this process can be omitted if the latest event file D1 has already been obtained from the drive recorder 2, in other processes (e.g. Step S23 in the FIG. 7).

Next, an “event occurrence location” of each event data is referenced and the number of “event occurrence locations” existing on the basic route is calculated (Step S34). The calculated number of the “event occurrence locations” is related to the basic route R1 and is displayed on the display 13 as shown in FIG. 11 (Step S35). In an example shown in FIG. 11, there are three warning marks 42 on the basic route R1, and therefore, the number of the “event occurrence locations” on the basic route is indicated as three locations.

Next, it is judged whether the number of the “event occurrence locations” existing on the basic route is three or more (Step S36). When the number of the “event occurrence locations” existing on the basic route is less than three (No at the Step S36), the basic route is decided to be used for route guidance, and the route guidance starts (Step S40).

On the other hand, when the number of the “event occurrence locations” existing on the basic route is three or more (Yes at the Step S36), some users may request another route due to relatively many event occurrence locations. In this case, a command button Ca indicated as “Finding detour route” and a command button Cb indicated as “Start route guidance” are displayed on the screen of the display 13 as shown in the FIG. 11. The user can select either the command button Ca or Cb by touching the screen. If the command button Cb of “Start route guidance” (No at the Step S37), the basic route is decided to be used for route guidance, and the route guidance starts (Step S40).

On the other hand, if the command button Ca of “Finding detour route” is selected (Yes at the Step S37), another route from the vehicle location to the destination is found through a detour algorithm, differing from the basic algorithm. In the detour algorithm, the shortest route from the vehicle location to the destination which circumvents the “event occurrence location” is selected. When the “event occurrence location” is on an expressway, or when it is near from the vehicle location, there are some cases that the user cannot circumvent the “event occurrence location.” However, the detour algorithm selects an optimum route which avoids the “event occurrence location”, to the extent possible (Step S38). Hereinafter, the route found by the detour algorithm is referred to as a “detour route.”

The detour route R2 found out is superimposed and displayed with the basic route R1 on the map displayed on the display 13 as shown in FIG. 12. In an example shown in FIG. 12, there are three warning marks 42 on the basic route R1, and there is no warning mark 42 on the detour route R2. In other words, the detour route R2 shown in FIG. 12 is a route that avoids all “event occurrence locations.”

Also in the detour route R2, the number of the “event occurrence locations” is calculated. The calculated number of the “event occurrence locations” on the detour route is related to the detour route R2 and is displayed on the display 13. Thereby, the user can compare the basic route R1 with the detour route R2 easily from the viewpoint of the number of the “event occurrence locations.” In addition, information such as a distance and a highway toll of each of the basic route R1 and of the detour route R2 also may be displayed.

If both the basic route R1 and the detour route R2 are displayed, command buttons C1 and C2 for selecting either the basic route R1 or the detour route R2 are displayed as shown in FIG. 12. The user can select a desired route between the basic route R1 and the detour route R2 by touching either the command button C1 or C2 (Step S39). After the user selects a route, the selected route is decided to be used for route guidance, and the route guidance starts (Step S40).

In this way, the route setting process calculates the number of the event occurrence locations existing on the route found out, and informs the user of the number of the event occurrence locations. Therefore, the user can recognize, before driving, the number of the locations existing on the route, where an attention is required for driving.

If there are three or more event occurrence locations on the basic route, the detour route that circumvents the event occurrence locations is found out by the user's instruction. Therefore, it is possible to reduce the number of the event occurrence locations existing on the route.

In above description, the detour route is found out if the number of the event occurrence locations is equal to or more than “three” as a threshold value. However, the threshold value that is used to find out the detour route is not limited to “three,” and the user can arbitrarily set any threshold value of “one” or more. Also, the threshold value may be set to be larger as a distance to a destination becomes longer. In above description, the detour route is found out after the user gives the instruction. However, the detour route may be found out automatically if the number of the event occurrence locations is equal to or more than the threshold value, to be offered to the user. Furthermore, it is acceptable to adopt an algorithm that takes account of an “event occurrence location” when the first basic route is found, and finds a route for circumventing that the “event occurrence location.”

### 1-7. Route Guidance

During route guidance, when the vehicle approaches an event occurrence location, the navigation apparatus 1 outputs a guidance sound that announces such approach.

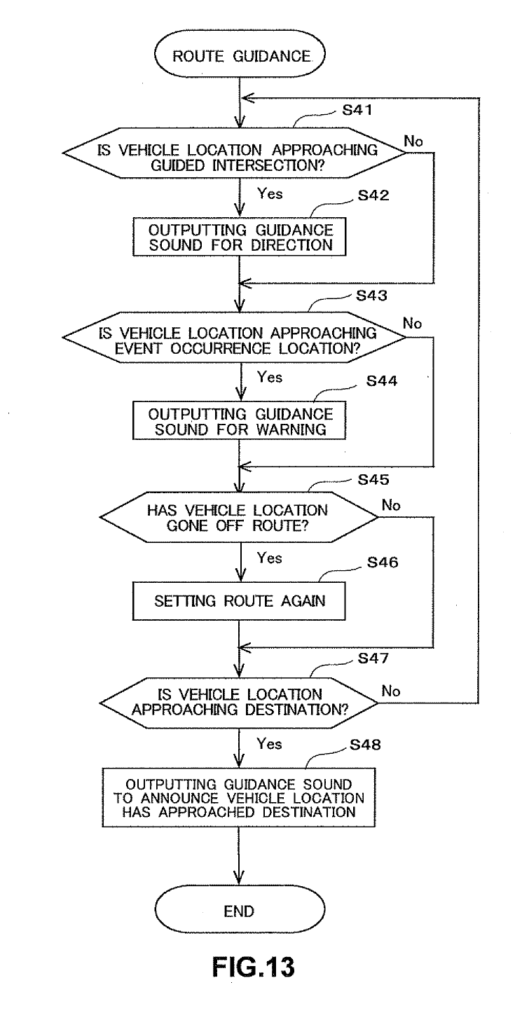

FIG. 13 shows a flow of a route guidance process where the navigation apparatus 1 provides route guidance from the vehicle location to a destination. This route guidance process is implemented under the control of the user guidance part 103 in the CPU 10 unless otherwise mentioned.

First, it is judged whether the vehicle location approaches an intersection where the user needs to turn (an intersection where a direction needs to be indicated), on the route (Step S41). If it is judged that the vehicle location approaches such intersection, an arrow that indicates the direction to turn at the intersection is displayed on the display 13, and the guidance sound that announces the direction is output from the speaker 14 (Step S42).

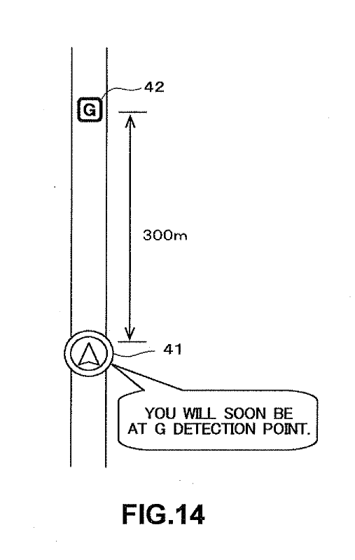

Subsequently, it is judged whether the vehicle location approaches an “event occurrence location” (Step S43). For example, as shown in FIG. 14, if there is an “event occurrence location” in the direction of travel of the vehicle 8 (on a side of the route, which the vehicle 8 is headed), and a distance on the route between the vehicle location (the vehicle mark 41) and the “event occurrence location” (the warning mark 42) is decreased to equal to or less than a predetermined distance (for example, 300 m), it is judged that the vehicle location has approached the “event occurrence location.” And if it is judged that the vehicle location has approached the “event occurrence location,” the guidance sound, warning that the vehicle location is approaching the event occurrence location, is output from the speaker 14 (Step S44).

The guidance sound being output at this time announces the type of the event that occurred at the “event occurrence location” where the vehicle location is approaching. For example, if the event type is “G detection,” the guidance sound announces “You will soon be at a G detection point.” If the event type is “rapid deceleration,” the guidance sound announces “You will soon be at a rapid deceleration point.” And if the event type is “switching operation,” the guidance sound announces “You will soon be at a switching operation point.”

In this way, the user is surely able to be conscious of a location needed to pay attention for driving before reaching to the location due to output of the guidance sound that announces the vehicle location has approached an “event occurrence location.”

Also, if the vehicle location goes of a route used for route guidance (Yes at the Step S45), the route from the vehicle location to a destination at that time is found out again by the route setting part 102, and is set as a route to be used for the route guidance (Step S46). In such second route finding, it is desirable to find a route through the basic algorithm if the last route given to the user is the basic route, and is desirable to find a route through the detour algorithm if the last route given to the user is the detour route.

If it is judged that the vehicle location has approached a destination (Yes at the Step S47), the guidance sound that announces the vehicle location has approached the destination is output from the speaker 14 (Step S48), and the route guidance process ends.

### 2. Second Embodiment

Next, the second embodiment is explained. The configuration and operation of an in-vehicle display system of the second embodiment is almost the same as that of the first embodiment, and therefore, the differences from the first embodiment are explained mainly.

A plurality of events may occur at a dangerous location for driving of the vehicle 8. Conversely it can be said that a location where a plurality of events occurred is a location having a high dangerous level and having a possibility that the event would occur again, and therefore, the user has to drive more carefully. In the second embodiment, an index based on the number of events that occurred is displayed on an “event occurrence location” on the map for showing the dangerous level.

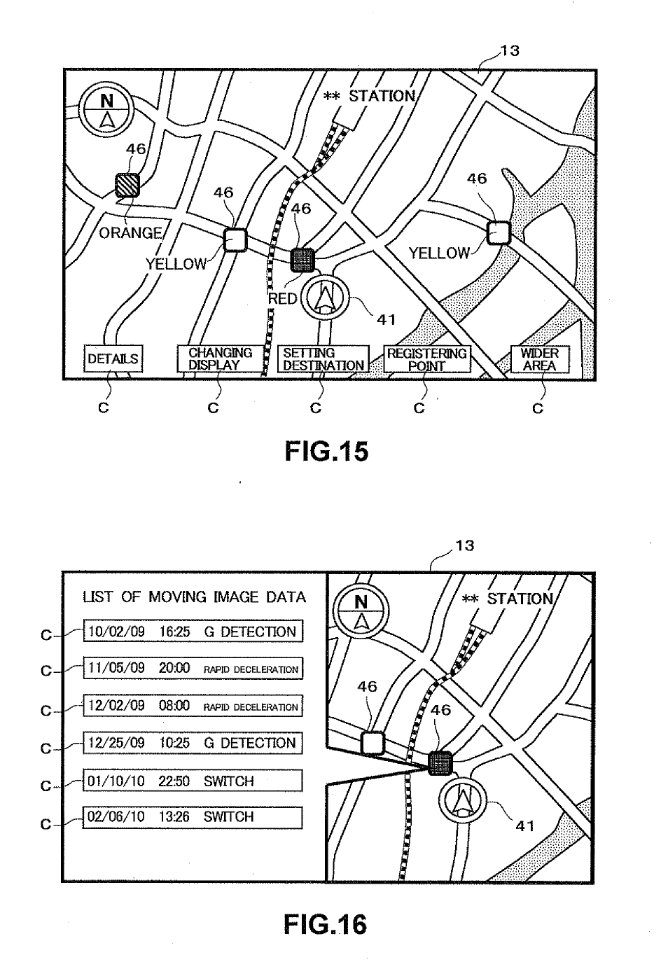

FIG. 15 shows a warning mark 46 displayed on a map displayed on the display 13 in the second embodiment. On an “event occurrence location” on the map, the warning mark 46 is displayed as an index based on the number of events that occurred at the location.

Concretely, a yellow warning mark 46 for one event occurrence, an orange warning mark 46 for two or more and less than five event occurrences, and a red warning mark 46 for five or more event occurrences are displayed respectively. The number of the events at each “event occurrence location” is calculated by the map display part 101, based on the “event occurrence location” of each event data in the event file D1.

The “event occurrence location” varies depending on each event strictly even if the event occurred at the same intersection and on the same road. Even if there is a distance between the “event occurrence locations” of a plurality of events, it can be assumed that the plurality of events occurred at the same location if the event occurrence locations are located within the width of the intersection and of the road on the location.

In this way, the kind of the warning mark 46 which is in accordance with the number of event occurrences is displayed on a location where an event occurred, on the map. Thereby, the user can easily understand to what level an attention is required. As a result, the user can drive keeping in mind the location where the user needs to drive more carefully, and then the safety is improved.

Also in the second embodiment, if any of the warning marks 46 on the map is selected, the moving image data D2 obtained at the “event occurrence location” of the selected warning mark 46 is played back and displayed. However, if the plurality of events occurred at the “event occurrence location,” a plurality of pieces of moving image data D2 for the respective events become subjects for playing back.

Therefore, if the warning mark 46 on the “event occurrence location” where the plurality of events occurred is selected, a list of information on the plurality of pieces of moving image data D2 obtained at the “event occurrence location” is displayed as shown in FIG. 16. In the displayed list, an “event time” and an “event type” are included as the information to identify each of the pieces of the moving image data. Also, the information of each of the pieces of the moving image data is indicated as the command buttons C. By selecting any of the command buttons C, the user can play back and display a desired piece of the moving image data D2.

### 3. Modification Examples

Hereinbelow, modifications are explained. Each of the embodiments explained above and below can be arbitrarily combined with one or more of the others.

In the embodiments described above, the explanation is given as follows: the navigation apparatus 1 and the drive recorder 2 are connected by the in-vehicle LAN 80, and recorded data recorded by the drive recorder 2 is transferred to the navigation apparatus 1 through the in-vehicle LAN 80. On the other hand, it is acceptable to transfer recorded data recorded by the drive recorder 2, to the navigation apparatus 1 through the memory card 9. In this case, the recorded data which is recorded in the memory card 9 by the drive recorder 2 is retrieved by the card slot 17 of the navigation apparatus 1 and recorded in the nonvolatile memory 12. And if the recorded data recorded by the drive recorder 2 is required for a variety of the processes in the navigation apparatus 1, necessary recorded data can be retrieved from the nonvolatile memory 12.

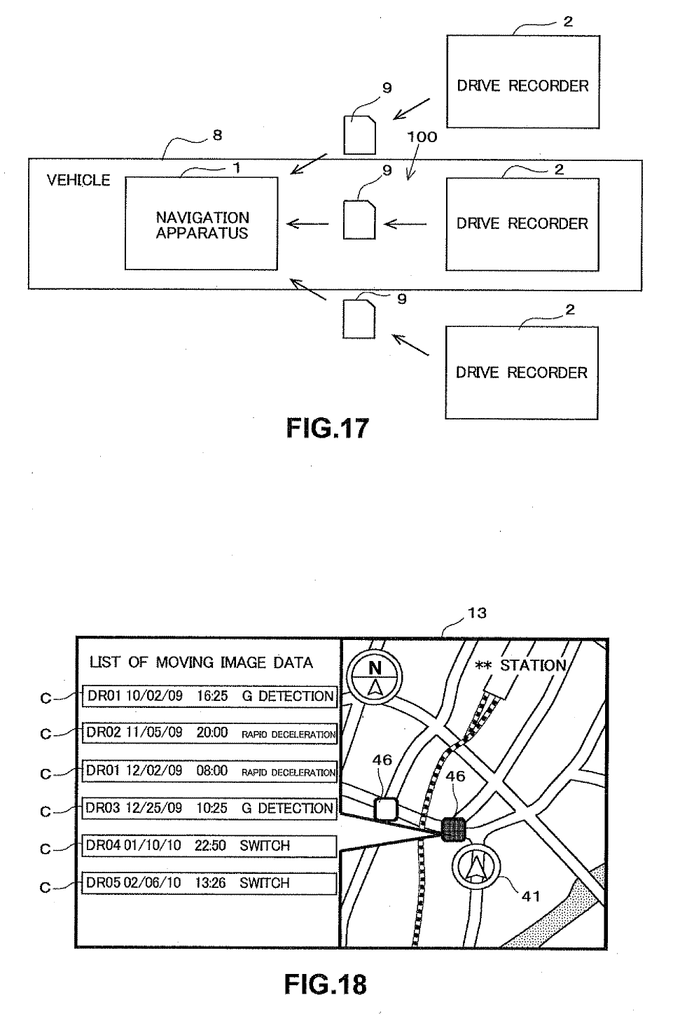

As shown in FIG. 17, it is also possible to utilize not only the recorded data recorded by the drive recorder 2 installed in the same vehicle 8 as the vehicle in which the navigation apparatus 1 is installed, but also recorded data recorded by the drive recorder 2 installed in another vehicle 8. Thereby, it is possible to inform a location where an attention is required, based on actual driving of a plurality of users.

In the example shown in FIG. 15, in many cases, a plurality of events are occurring at the same “event occurrence location.” Therefore, as in the second embodiment, if the warning mark 46 on the “event occurrence location” where the plurality of events occurred is selected, the list of information on the plural pieces of moving image data D2 obtained at the “event occurrence location” is displayed as shown in FIG. 18 so that the user can play back and display a desired piece of the moving image data D2. It is desirable that the information for identifying the respective pieces of the moving image data includes “identification information” to identify the drive recorders 2 which obtained the respective pieces of moving image data, as well as an “event time” and an “event type.” In the example in FIG. 18, “DR01,” “DR02,” and the like are “identification information” of the drive recorder 2.

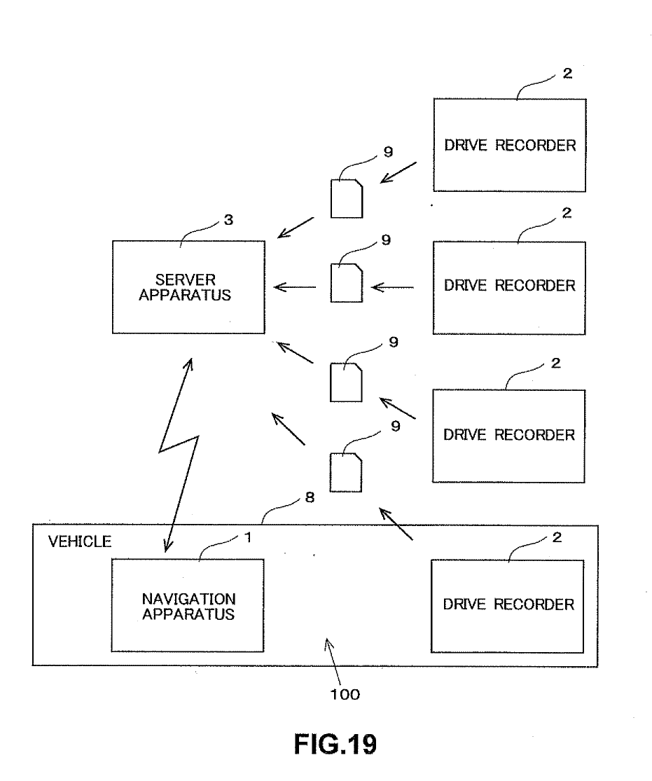

As shown in FIG. 19, it is acceptable to aggregate and record recorded data recorded by the drive recorder 2 installed in a plurality of vehicles, into a predetermined server apparatus 3, so that the navigation apparatus 1 can obtain the recorded data recorded by the drive recorder 2 from the server apparatus 3 through wireless communication. This makes it possible to inform a location where an attention is required, based on actual driving of more users.

In the embodiments described above, the drive recorder 2 records moving image data in response to occurrence of an event. However, the drive recorder 2 may record moving image data constantly while the drive recorder 2 is running, regardless of occurrence of an event. Even in this case, the drive recorder 2 is to record moving image data that shows the surroundings of the vehicle at the time of event occurrence because the drive recorder 2 records moving image data constantly while the drive recorder 2 is running.

Also in the embodiments described above, a guidance sound is output when the vehicle location approaches an event occurrence location during route guidance. However it is acceptable to output a guidance sound when the vehicle location approaches an event occurrence location even if route guidance is not provided.

Also in the embodiments described above, the navigation apparatus 1 arbitrarily obtains recorded data, required for display, from the drive recorder 2. On the other hand, it is acceptable to record the same data as recorded data recorded by the drive recorder 2 into the nonvolatile memory 12 in the navigation apparatus 1, and to retrieve necessary recorded data from the nonvolatile memory 12.

In the navigation apparatus 1 installed in a certain vehicle, it is acceptable to obtain an “event occurrence location” recorded by the drive recorder 2 installed in another vehicle and to display the “event occurrence location” of an event caused by another vehicle, on the map. In this case, it is desirable to obtain an “event type” as well as the “event occurrence location” and to display a warning mark based on the type of the event that occurred.

In the embodiments described above, a variety of functions are implemented by software as a result of performance of arithmetic processing of the CPU in accordance with the program. However, a part of the functions may be implemented by an electrical hardware circuit. Contrarily, a part of the functions implemented by the hardware circuit in the above-described embodiments may be implemented by the software.

While the invention has been shown and described in detail, the foregoing description is in all aspects illustrative and not restrictive. It is therefore understood that numerous other modifications and variations can be devised without departing from the scope of the invention.

What is claimed is:

1. A navigation apparatus for installation in a vehicle, the navigation apparatus comprising:
a data obtaining unit that obtains recorded data, recorded by a drive recorder that records the recorded data including an event occurrence location where an event occurred;
a location obtaining unit that obtains a vehicle location that is a current location of the vehicle; and
a display unit that displays a map that explicitly identifies the event occurrence location and the vehicle location.

2. The navigation apparatus according to claim 1, wherein
the recorded data further includes a type of the event, and
the display unit explicitly identifies the type of the event that occurred at the event occurrence location, on the event occurrence location on the map.

3. The navigation apparatus according to claim 1, wherein
the recorded data includes a plurality of the event occurrence locations and further includes moving image data that shows image data recorded when the event occurred at each respective event occurrence location, and
the navigation apparatus further comprises a receiver that receives a selection of any of the plurality of event occurrence locations on the map from a user, and
the display unit plays back and displays the moving image data of the event that occurred at one of the plurality of the event occurrence locations which is selected by the user.

4. The navigation apparatus according to claim 1, wherein
the display unit displays an index in accordance with how many times the event occurred at the event occurrence location, on the event occurrence location on the map.

5. The navigation apparatus according to claim 1, further comprising:
a route finding unit that finds a first route from the vehicle location to a destination; and
a number calculating unit that calculates the number of the event occurrence locations existing on the first route.

6. The navigation apparatus according to claim 5, further comprising:
an informing unit that informs a user of the number of the event occurrence locations existing on the first route.

7. The navigation apparatus according to claim 5, wherein
the route finding unit finds a second route that circumvents the event occurrence location if the number of the event occurrence locations existing on the first route is equal to or above a threshold value.

8. The navigation apparatus according to claim 1, further comprising:
a route setting unit that is capable of finding a route from the vehicle location to a destination, which circumvents the event occurrence location.

9. The navigation apparatus according to claim 1, further comprising:
a sound output unit that outputs a guidance sound that announces that the vehicle location is approaching the event occurrence location, when the vehicle location is within a predetermined distance of the event occurrence location.

10. The navigation apparatus according to claim 1, wherein the recorded data includes moving image data showing the event that occurred at the event occurrence location, and the display unit shows the moving image data when instructed to do so by a user of the navigation apparatus.

11. The navigation apparatus according to claim 1, wherein the recorded data for the event is recorded when the event occurs.

12. An in-vehicle display system for installation in a vehicle, the in-vehicle display system comprising:
a drive recorder that records recorded data including an event occurrence location where an event occurred;
a location obtaining unit that obtains a vehicle location that is a current location of the vehicle; and
a display unit that displays a map that explicitly identifies the event occurrence location and the vehicle location.

13. The in-vehicle display system according to claim 12, wherein
the recorded data further includes a type of the event, and
the display unit explicitly identifies the type of the event that occurred at the event occurrence location, on the event occurrence location on the map.

14. The in-vehicle display system according to claim 12, wherein
the recorded data includes a plurality of the event occurrence locations and further includes moving image data that shows image data recorded when the event occurred at each respective event occurrence location, and
the in-vehicle display system further comprises a receiver that receives a selection of any of the plurality of event occurrence locations on the map from a user, and
the display unit plays back and displays the moving image data of the event that occurred at one of the plurality of event occurrence locations which is selected by the user.

15. The in-vehicle display system according to claim 12, wherein
the display unit displays an index in accordance with how many times the event occurred at the event occurrence location, on the event occurrence location on the map.

16. The in-vehicle display system according to claim 12, further comprising:
a route finding unit that finds a first route from the vehicle location to a destination; and
a number calculating unit that calculates the number of the event occurrence locations existing on the first route.

17. The in-vehicle display system according to claim 12, wherein the recorded data includes moving image data showing the event that occurred at the event occurrence location, and the display unit shows the moving image data when instructed to do so by a user of the in-vehicle display system.

18. The in-vehicle display system according to claim 12, wherein the recorded data for the event is recorded when the event occurs.

19. A map displaying method for displaying a map in a vehicle, the method comprising the steps of:
(a) obtaining recorded data, recorded by a drive recorder that records the recorded data including an event occurrence location where an event occurred;
(b) obtaining a vehicle location that is a current location of the vehicle; and
(c) displaying a map that explicitly identifies the event occurrence location and the vehicle location.

20. The map displaying method according to claim 19, wherein
the recorded data further includes a type of the event, and
the step (c) explicitly identifies the type of the event that occurred at the event occurrence location, on the event occurrence location on the map.

21. The map displaying method according to claim 19, wherein
the recorded data includes a plurality of the event occurrence locations and further includes moving image data that shows image data recorded when the event occurred at each respective event occurrence location, and
the map displaying method further comprises the steps of:
(d) receiving a selection of any of the plurality of event occurrence locations on the map from a user; and
(e) playing back and displaying the moving image data of the event that occurred at one of the plurality of event occurrence locations which is selected by the user.

22. The map displaying method according to claim 19, wherein
the step (c) displays an index in accordance with how many times the event occurred at the event occurrence location, on the event occurrence location on the map.

23. The map displaying method according to claim 19, the method further comprising the steps of:
(f) finding a first route from the vehicle location to a destination; and
(g) calculating the number of the event occurrence locations existing on the first route.

24. The map displaying method according to claim 23, the method further comprising the step of:
(h) informing a user of the number of the event occurrence locations existing on the first route.

25. The map displaying method according to claim 19, wherein the recorded data includes moving image data showing the event that occurred at the event occurrence location, and the displaying step shows the moving image data.

26. The map displaying method according to claim 19, wherein the recorded data for the event is recorded when the event occurs.
